(19) United States
(12) Patent Application Publication
(10) Pub. No.: US 2014/0076277 A1
(43) Pub. Date: Mar. 20, 2014

(54) CARBURETOR WITH INTEGRATED CABLE RETAINER

(71) Applicant: David Shebuski, Franklin, TN (US)

(72) Inventor: David Shebuski, Franklin, TN (US)

(73) Assignee: Zama Japan Kabushiki Kaisha

(21) Appl. No.: 13/784,672

(22) Filed: Mar. 4, 2013

Related U.S. Application Data
(60) Provisional application No. 61/606,863, filed on Mar. 5, 2012.

(51) Int. Cl. F02M 17/00

(52) U.S. Cl. CPC F02M 17/00
USPC 123/337

(57) ABSTRACT

A carburetor comprising a throttle cable housing mountable over a throttle cable and couplable to a retainer or receptacle that is an integrated part of the carburetor assembly. The throttle cable housing is configured with a molded protrusion that snaps into the retainer or receptacle on the carburetor so that once installed the throttle cable housing cannot be removed without a special tool. The retainer or receptacle accepts the snap in throttle cable housing and can be positioned in a variety of ways to facilitate the requirements of the engine manufacturer. In a rotary carburetor, the retainer or receptacle is preferable formed on the rotor cover. In a carburetor with a butterfly throttle valve, the retainer or receptacle is preferable formed as an integrated part of the metering chamber cover.

### CROSS-REFERENCE TO RELATED APPLICATION

This application claims the benefit of U.S. Provisional Application No. 61/606,863, which application is incorporated herein by reference.

### FIELD OF THE INVENTION

The embodiments described herein relate to a carburetor and, more particularly to a carburetor with an integrated cable retainer.

### BACKGROUND OF THE INVENTION

Most carburetors on small internal combustion engines control engine speed with a throttle valve or barrel. The valve or barrel is mounted to a throttle shaft. Carburetors using a throttle valve (butterfly valve) have a throttle shaft that is assembled into a bore which is machined transversely to the throttle bore of the carburetor. The valve is attached to the shaft so that it aligns with the throttle bore. As the shaft rotates the valve opens the throttle bore passage, allowing air to flow through the bore to the engine. Carburetors with a barrel have a shaft that is mounted axial to the barrel. The barrel has a hole located transverse to the axis of the barrel. The shaft and barrel are assembled into the carburetor so that the hole in the barrel aligns with a bore in the carburetor body. As the shaft rotates it changes the alignment of the hole in the barrel with the throttle bore, controlling the flow of air through the throttle bore.

in both cases a lever is attached to one end of the shaft. A cable is attached to the lever. The cable is contained in a housing. Movement of the cable back and forth in the housing moves the lever and rotates the shaft. The cable housing is held in place by several different means. The two most common methods are: (1) A metal retaining bolt that is screwed into a bracket or housing on the carburetor. This method tends to complicate the assembly process. (2) A special clip which is molded to the cable housing and attaches to a retainer on the engine. This method tends to limit the options for orientation of the carburetor on the engine, tends to require the engine manufacturer to design and tool special components that facilitate mounting of the throttle cable, and tends to give rise to tolerance stack up issues for the throttle cable assembly.

It is desirable to provide an improved throttle cable assembly that reduces or eliminates the drawbacks associate with conventional throttle cable assembly systems and methods.

### SUMMARY OF THE INVENTION

The embodiments described herein provide a carburetor with a throttle cable housing mountable over a throttle cable and culpable to a retainer or receptacle that is an integrated part of the carburetor assembly. The throttle cable housing is configured with a molded protrusion that snaps into the retainer or receptacle on the carburetor so that once installed the throttle cable housing cannot be removed without a special tool. The retainer or receptacle accepts the snap in throttle cable housing and uses no other components to contain the throttle cable housing. The retainer or receptacle can be positioned in a variety of ways to facilitate the requirements of the engine manufacturer. In a rotary carburetor, the retainer or receptacle is preferable formed on the rotor cover. In a carburetor with a butterfly throttle valve, the retainer or receptacle is preferable formed as an integrated part of the metering chamber cover.

Further, objects and advantages of the invention will become apparent from the following detailed description.

### BRIEF DESCRIPTION OF THE DRAWINGS

FIG. 1 is a partial exploded perspective view of a rotary carburetor with an integrated throttle cable housing receptacle and a throttle cable housing mountable thereto.

FIG. 2 is a fully assembled perspective view of the rotary carburetor in FIG. 1 with the throttle cable housing mounted to the integrated throttle cable housing receptacle.

FIG. 3 is an end view of the throttle cable housing.

FIG. 4 is a perspective view of a partial assembly of the throttle cable housing and throttle cable.

FIG. 5 is a fully assembled perspective view of a rotary carburetor with the integrated throttle cable housing receptacle and a throttle cable housing with angled cable guide mounted thereto.

FIG. 6 is a perspective view of a partial assembly of the throttle cable and throttle cable housing with an angled cable guide.

FIG. 7 is a fully assembled perspective view from the metering cover perspective of a butterfly throttle valve carburetor with an integrated throttle cable housing retainer and a throttle cable housing mounted thereto.

FIG. 8 is a fully assembled perspective view from the throttle bore perspective of the butterfly throttle valve carburetor in FIG. 7.

FIG. 9 is a perspective view of a partial assembly of the throttle cable housing and the throttle cable.

### DETAILED DESCRIPTION OF THE PREFERRED EMBODIMENTS

The embodiments described herein with reference to the drawings provide a carburetor with Throttle cable housing mountable over a throttle cable and couplable to a retainer or receptacle that is an integrated part of the carburetor assembly. The throttle cable housing is configured with a molded protrusion that snaps into the retainer or receptacle on the carburetor so that once installed the throttle cable housing cannot be removed without a special tool. The retainer or receptacle accepts the snap in throttle cable housing and uses no other components to contain the throttle cable housing. The retainer or receptacle can be positioned in a variety of ways to facilitate the requirements of the engine manufacturer. In a rotary carburetor, the retainer or receptacle is preferable formed on the rotor cover. In a carburetor with a butterfly throttle valve, the retainer or receptacle is preferable formed as an integrated part of the metering chamber cover.

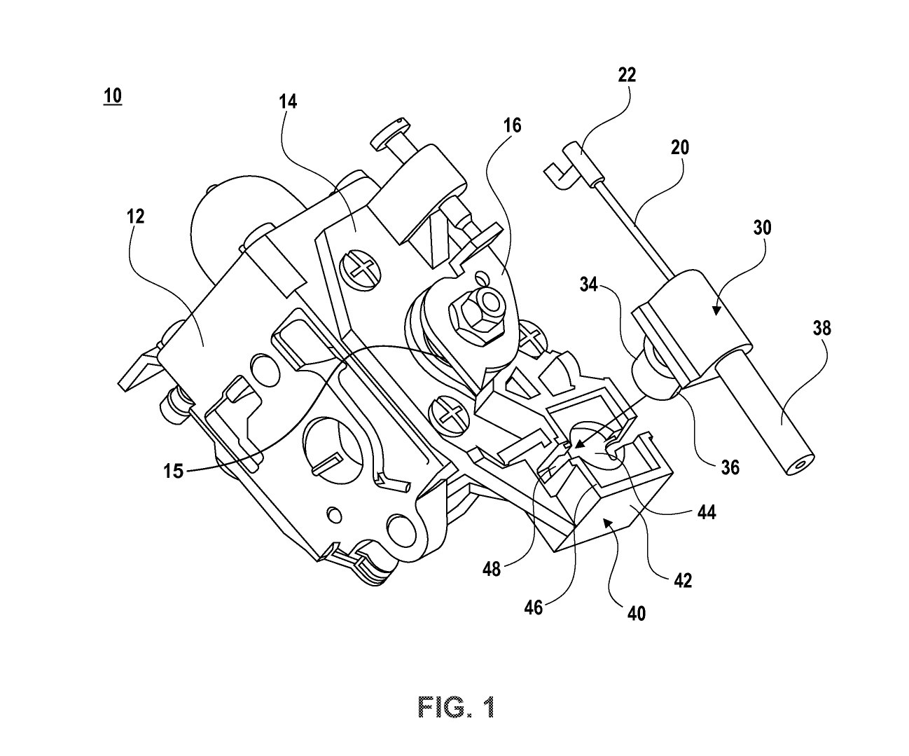

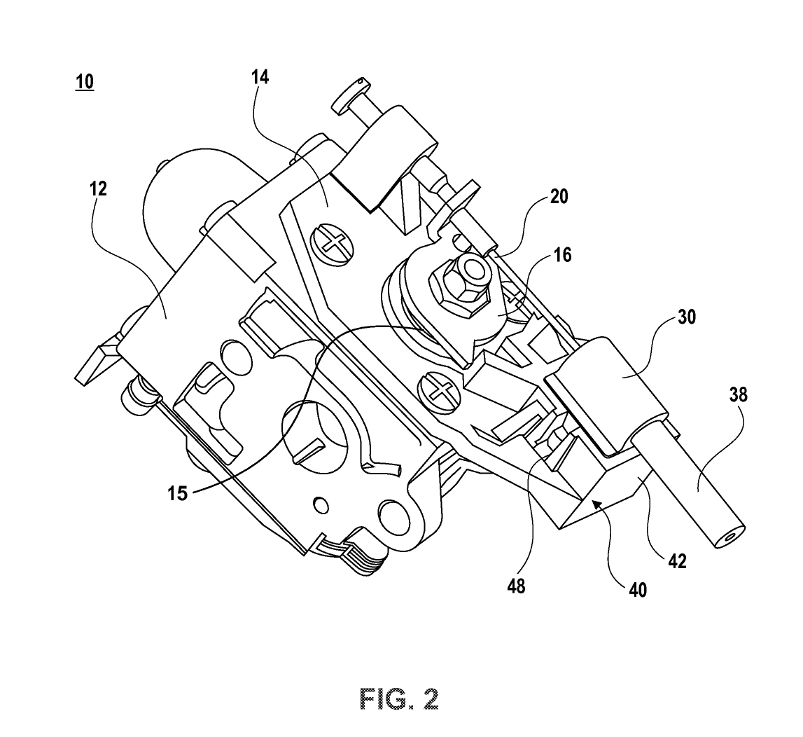

Referring to FIGS. 1 and 2, a rotary carburetor 10 is depicted having a body 12, a rotor cover 14 mounted on the body 12 and a throttle lever 16 coupled to a shaft 15 that extends through the rotor cover 14 into the body to a throttle barrel rotatably received in the body 12. A throttle cable housing receptacle 40 is formed as an integrated part of the rotor cover 14 and is configured to lockably receive a cable housing 30. The cable housing 30 is mountable over a throttle cable 20 extending from an engine throttle. The throttle cable 20 includes a lever hook 22 to operably couple the throttle cable 20 to the throttle lever 16. Movement of the throttle cable 20 through the throttle cable housing 30 causes rotational movement of the throttle lever 16 and, thus, rotation of the throttle shaft 15 and throttle barrel.

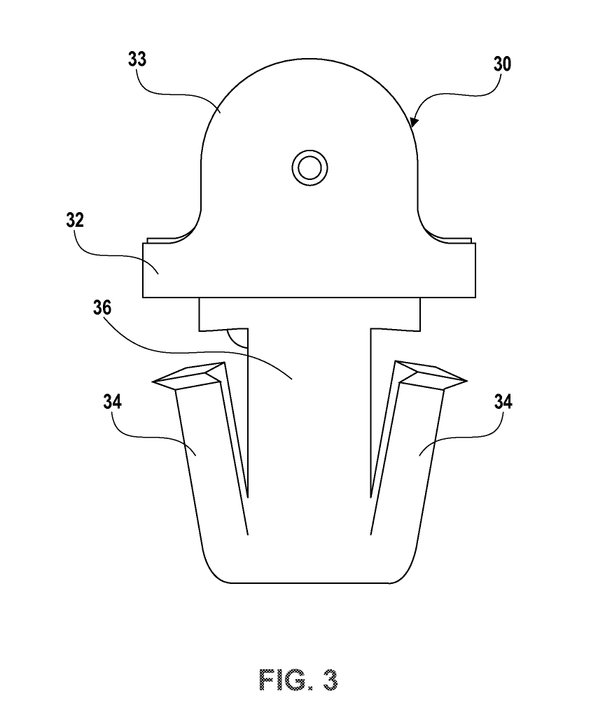

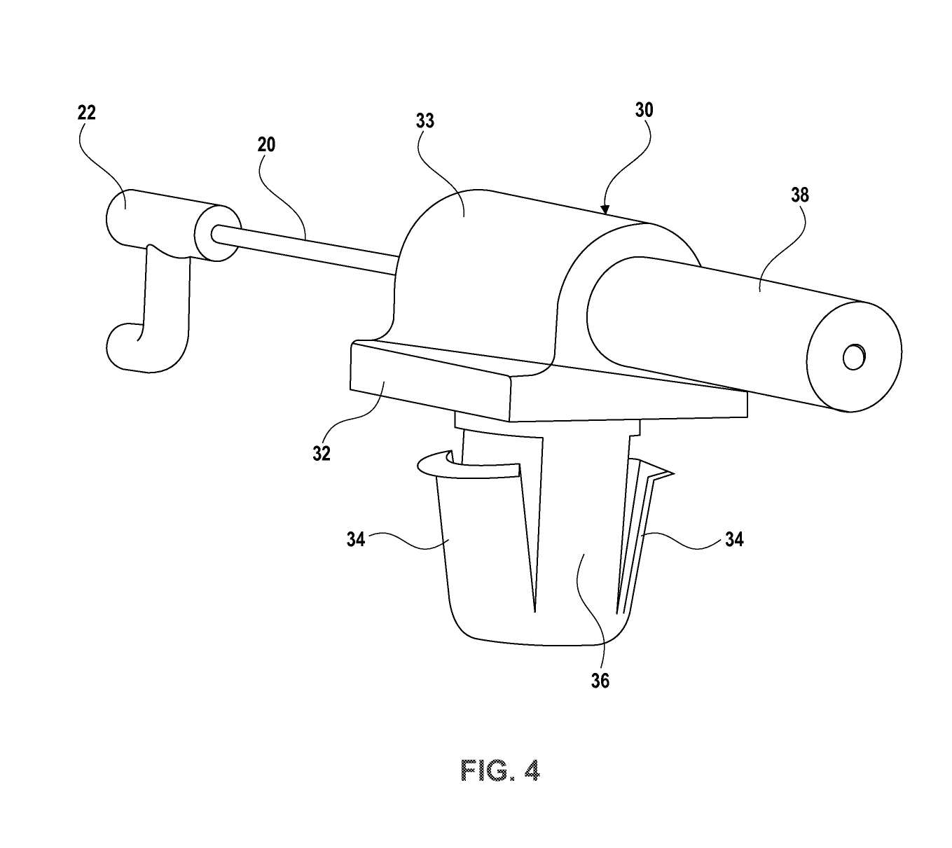

As shown in FIGS. 3 and 4, the throttle cable housing 30 has a tubular body 33 coupled to or integrally formed with a base 32. Extending from the tubular body 33 is a cable guide tube 38. A mounting protrusion or post 36 extends from the base 32 and includes one or more outwardly biased retention arms 34 outwardly extending back toward the base 32 from a position in spaced relation with the base 32.

Turning back to FIGS. 1 and 2, the cable housing receptacle 40 includes a body 42 with side walls extending up from the surface of the rotor cover 14 and one or more stop plates 46 extending laterally from the side walls. A hole 44 for receiving the mounting protrusion 36 of the cable housing 30 extends into the hole 44 through the one or more stop plates 46.

To assemble, the throttle cable 20 is passed through the guide tube 38 and tubular housing 33 and then the lever hook 22 is secured to the end of the throttle cable 20. With the cable housing 30 mounted on the throttle cable 20, the mounting protrusion 36 of the cable housing 30 is pushed through the receiving hole 44 with the retention arms 34 being deflected inwardly until the retention arms 34 reach a position passed the stop plates 46, at which time the retention arms 34 snap back to their original outwardly biased orientation with the free ends of the retention arms 34 abutting the stop plates 46. One or more access slots 48 are formed in the side walls of the body 42 of the receptacle 40 to enable release of the cable housing 30 from the receptacle 40 using a special tool.

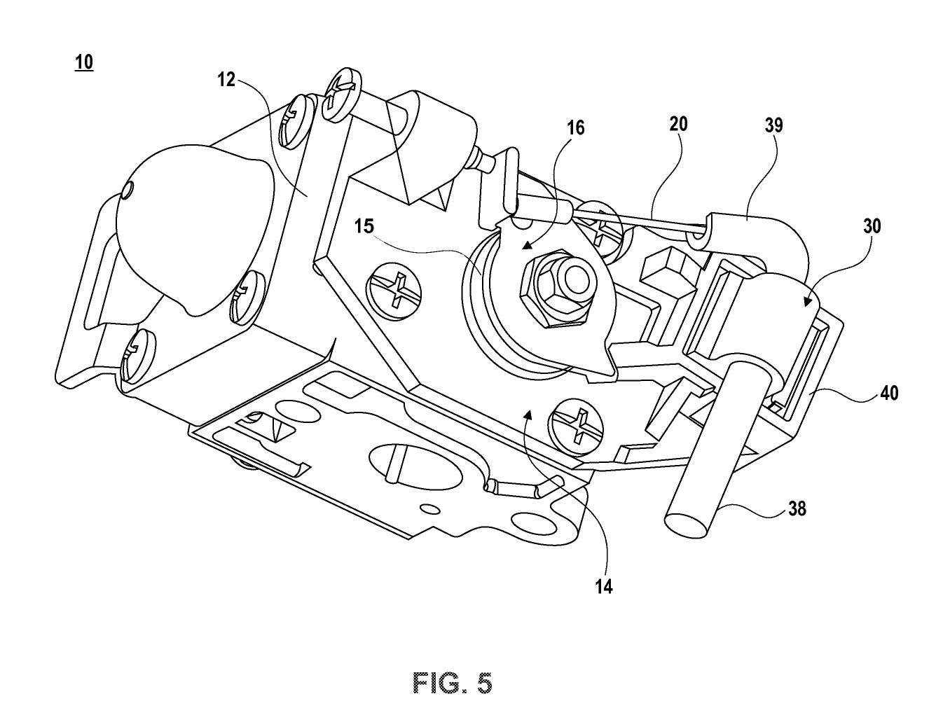

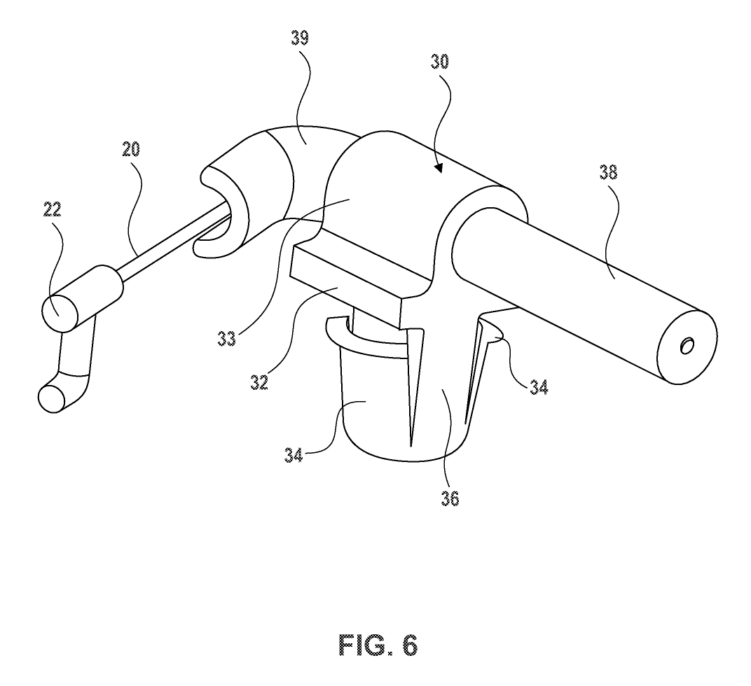

Turning to FIGS. 5 and 6, the cable housing 30 is shown to include an angled cable guide 39 extending from the tubular body 33 and extending at an angle relative to the longitudinal axis of the cable guide tube 38. As depicted, the angle to which the cable guide 39 is oriented relative to the cable guide tube 38 is about 90 degrees but can vary to enable a variety of orientations of the carburetor 10 relative to an engine to which it is to be coupled.

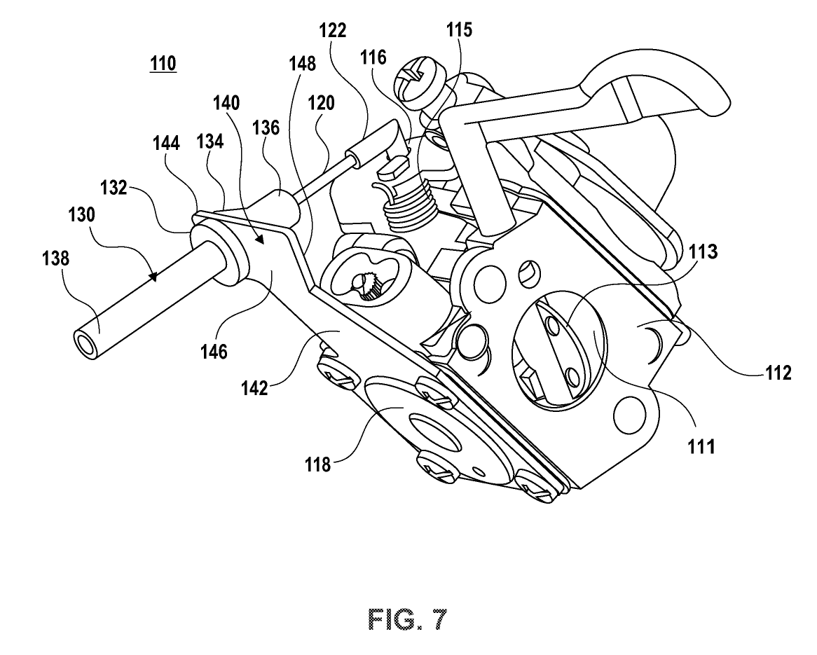

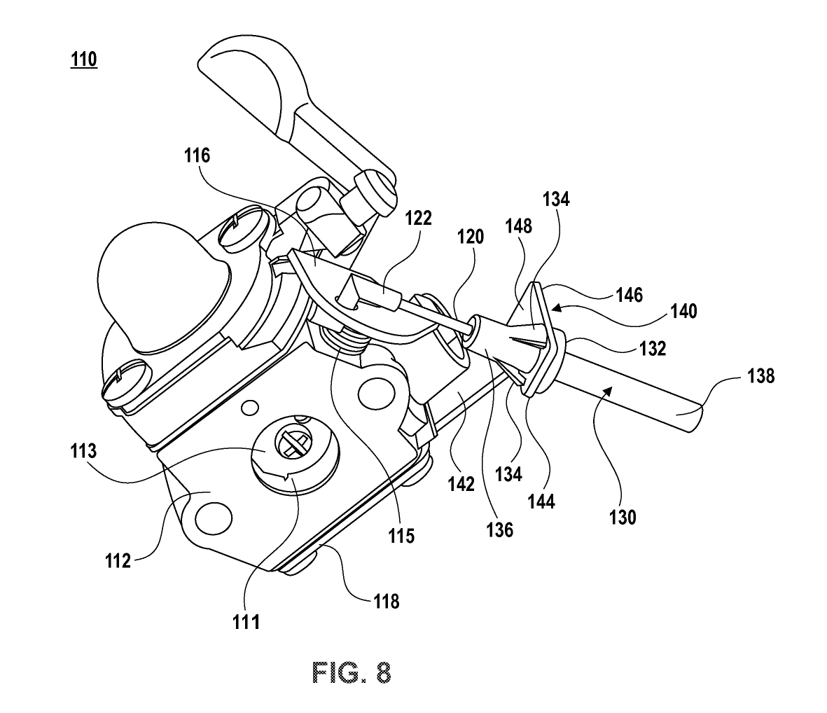

Referring to FIGS. 7 and 8, a carburetor 110 is depicted having a body 112, a butterfly throttle valve 113 received in a throttle bore 111 in the body 112, a throttle lever 116 coupled to a shaft 115 that extends through the body 112 to the throttle valve 113. A throttle cable housing retainer 140 is formed as an integrated part of a metering chamber cover 118 and is configured to lockably receive a cable housing 130. The cable housing 130 is mountable over a throttle cable 120 extending from an engine throttle. The throttle cable 120 includes a lever hook 122 to operably couple the throttle cable 120 to the throttle lever 116. Movement of the throttle cable 120 through the throttle cable housing 130 causes rotational movement of the throttle lever 116 and, thus, rotation of the throttle shaft 115 and throttle valve 113.

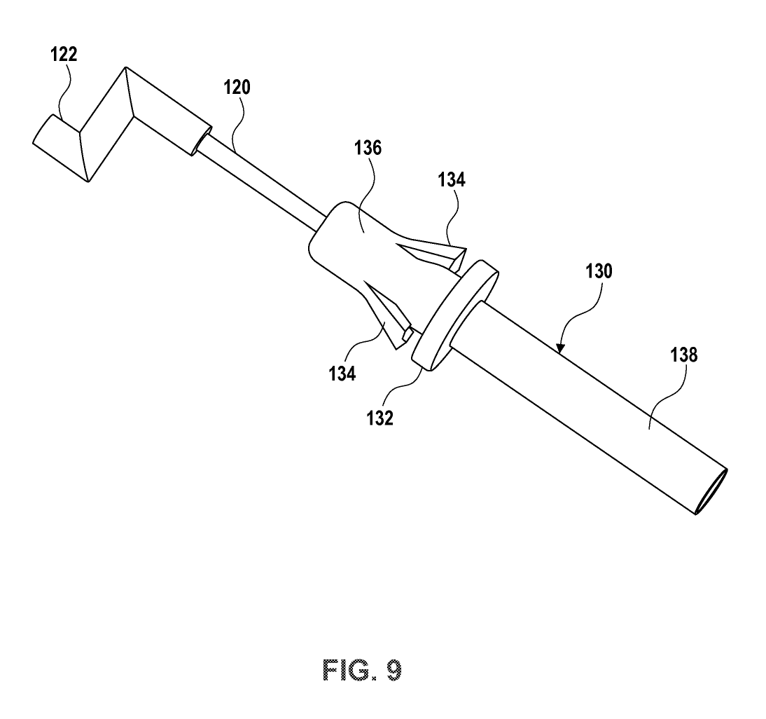

As shown in FIG. 9, the throttle cable housing 130 has a tubular guide body 138 with an annular base 132 extending outwardly there from. The tubular guide body 138 includes a mounting portion 136 that extends from the base 132 towards the end of the throttle cable 120 and includes one or more outwardly biased retention arms 134 outwardly extending back toward the base 132 from a position in spaced relation with the base 132.

Turning back to FIGS. 7 and 8, the cable housing retainer 140 includes a retainer arm 142 extending from the metering chamber cover 118 and a retaining base 144 with a hole for receiving the mounting protrusion portion 136 of the guide body 138 of the cable housing 130 extending through the retaining base 144.

To assemble, the throttle cable 120 is passed through the guide body 138 of the cable housing 130 and then the lever hook 122 is secured to the end of the throttle cable 120. With the cable housing 130 mounted on the throttle cable 120, the mounting protrusion portion 136 of the cable housing 130 is pushed through the receiving hole in the retaining base 144 with the retention arms 134 being deflected inwardly until the cable housing base 132 abuts the bottom surface 146 of the retainer base 144 and the retention arms 134 reach a position passed the retainer base 144, at which time the retention arms 134 snap back to their original outwardly biased orientation with the free ends of the retention arms 134 abutting the top surface 148 of the retainer base 144. Once snapped in place, the cable housing 130 can only be released from the cable housing retainer 140 using a special tool.

While the invention is susceptible to various modifications, and alternative forms, specific examples thereof have been shown in the drawings and are herein described in detail. It should be understood, however, that the invention is not to be limited to the particular forms, or methods disclosed, but to the contrary, the invention is to cover all modifications, equivalents and alternatives falling within the spirit, and scope of the appended claims.

What is claimed is:

1. A carburetor comprising
a body,
a throttle valve mounted within the body,
a throttle lever coupled to the throttle valve,
a throttle cable housing retainer coupled to the body, and
a throttle cable housing configured to receive a throttle cable couplable to the throttle lever and configured to be loci ably received in the throttle cable housing.

2. The carburetor of claim 1 wherein the throttle cable housing retainer is an integrated part of a metering chamber cover coupled to the body.

3. The carburetor of claim 2 wherein the throttle valve is a butterfly throttle valve.

4. The carburetor of claim 2 wherein the throttle cable housing retainer includes an arm extending from the metering chamber cover and a base plate extending from the end of the arm in spaced relation with the metering chamber cover.

5. The carburetor of claim 4 wherein the throttle cable housing includes
an elongate body,
a base extending from the body, and
one or more retention arms extending outward toward the base from a position in space relation to the base, wherein the one or more retention arms are outwardly biased.

6. The carburetor of claim 5 wherein the one or more retention arms deflect inwardly as the elongate body is passed through a hole in the base plate and springs back into position when the one or more retention arms pass beyond the base plate.

7. The carburetor of claim 6 wherein free ends of the one or more retention arms and the base of the throttle cable housing abut opposing sides of the base plate of the retainer when the cable housing is mounted to the retainer.

8. The carburetor of claim 1 wherein the retainer is an integrated part of a rotor cover coupled to the body.

9. The carburetor of claim 1 wherein the throttle valve is a rotary barrel throttle valve.

10. The carburetor of claim 8 wherein the retainer includes a body with side walls extending from the rotor cover and a stop plate extending laterally from the ends of the side walls in spaced relation with the rotor cover.

11. The carburetor of claim 10 wherein the throttle cable housing includes
a tubular body,
a base extending from the body,
a mounting protrusion extending from the base, and
one or more retention arms extending outward toward the base from a position in space relation to the base, wherein the one or more retention arms are outwardly biased.

12. The carburetor of claim 11 wherein the one or more retention arms deflect inwardly as the mounting protrusion is passed through a hole in the stop plate and springs back into position when the one or more retention arms pass beyond the stop plate.

13. The carburetor of claim 12 wherein free ends of the one or more retention arms and the base of the throttle cable housing abut opposing sides of the stop plate of the retainer when the cable housing is mounted to the retainer.

14. The carburetor of claim 13 wherein the stop plate includes plurality of stop plates.

15. The carburetor of claim 13 wherein the cable housing includes an elongate guide tube extending from the body.

16. The carburetor of claim 15 wherein the cable housing includes a cable guide extending from the body at angle to a longitudinal axis of the elongate guide tube.
